(19) United States
(12) Patent Application Publication
(10) Pub. No.: US 2014/0137028 A1
(43) Pub. Date: May 15, 2014

(54) Touch-sensitive electric apparatus and window operation method thereof

(71) Applicants: Mert YENTÜR, Zürich (CH); Alexandra SABELNIKOVA, Zürich (CH)

(72) Inventors: Mert YENTÜR, Zürich (CH); Alexandra SABELNIKOVA, Zürich (CH)

(21) Appl. No.: 13/672,929

(22) Filed: Nov. 9, 2012

(51) Int. Cl. G06F 3/0485

(52) U.S. Cl. CPC G06F 3/0485
USPC 715/784

(57) ABSTRACT

A window operation method for use in an electronic device (10) comprises a touch-sensitive screen (20), a storage unit and a processing module, wherein pointers to slides of a graphical presentation are stored in a database within the storage unit. Then the method applies the steps of storing a touch-control database comprising at least two touch-control events and an assessment field in the storage unit or each pointer to a slide, generating a slide of the graphical representation and a transparent window, displaying the slide of the graphical representation and the transparent window on top of it on the touch-sensitive screen by the processing module, wherein the transparent window comprises said touch-control events, analyzing a touch-control command received via the touch-sensitive screen by the processing module, and determining whether the touch-control command conforms to one of the stored touch-control events, wherein, when the touch-control command conforms to one of the stored touch-control events, an assessment figure is stored in the assessment field in the storage unit for the current pointer to a slide.

### TECHNICAL FIELD

The present invention relates to a touch-sensitive electric apparatus and window operation method, for use in an electronic device comprising a touch-sensitive screen, a storage unit and a processing module, wherein pointers to slides of a graphical presentation are stored in a database within the storage unit.

### PRIOR ART

A method for gesture control in relation with touch sensitive screens is known from EP 2 372 513, providing transparent windows adapted to be manipulated when other windows are also displayed on the sensitive screen.

WO 2011/056387 provides a multi-touch control which uses a function similar to a double touch opening of menus as known in connection with the use of context menus and computer mice in use with conventional screens.

When a presentation is given with the use of slides shown on a computer screen it is often a need for the person giving the representation to make notes relating to the reaction of the target audience on the presentation of slides. For the time being, there is no technical means to provide an easy solution for supporting the user, so that he is forced to memorize the reactions. This is especially true, when a face-to-face situation exists where a tablet computer with a touch-sensitive screen is used.

### SUMMARY OF THE INVENTION

Based on this prior it is therefore an object of the invention to provide a method and a device attending to this deficit. It is also an aim to provide directly a possibility for storing such feedback information for easy later retrieval. Furthermore it is contemplated to improve the knowledge of use of different presentation materials as slides or pages of an electronic book, e.g. a PDF document.

The invention is based on the inside, that modern tablet computers having a touchscreen interface wherein the user of the touchscreen can directly combine giving a notation of a slide being presented together with the normal use of the presentation tools.

### BRIEF DESCRIPTION OF THE DRAWINGS

Preferred embodiments of the invention are described in the following with reference to the drawings, which are for the purpose of illustrating the present preferred embodiments of the invention and not for the purpose of limiting the same. In the drawings,

FIG. 1 shows a representation of an electronic device as a tablet computer providing a slide representation executing a method according to the invention;

FIG. 2 shows a block diagram illustrating an embodiment of the electronic device according to the invention.

### DESCRIPTION OF PREFERRED EMBODIMENTS

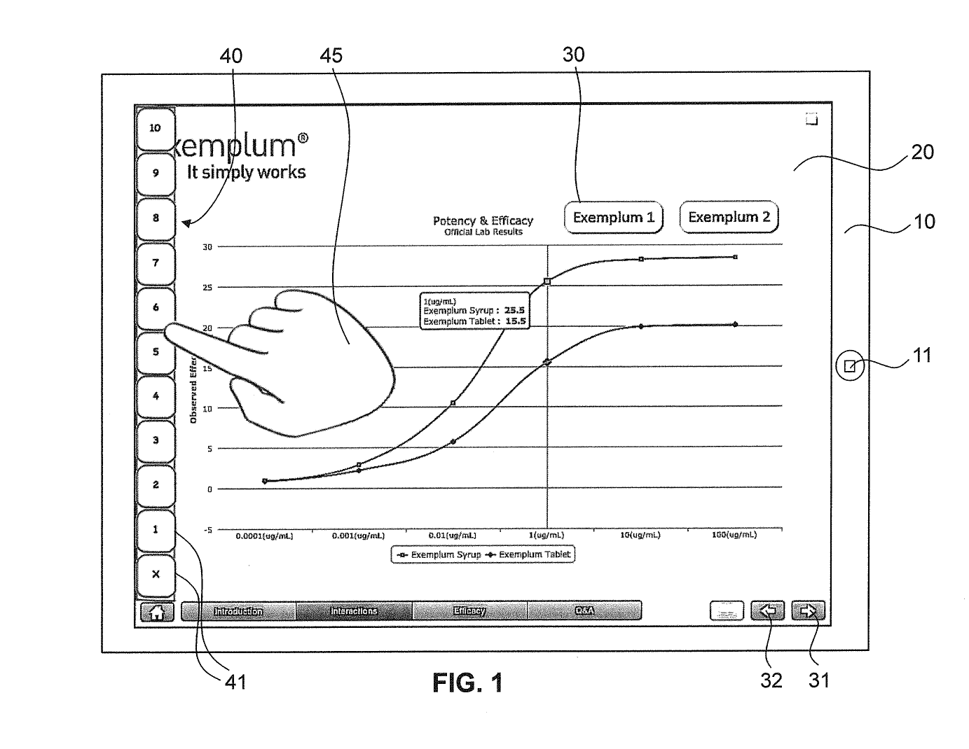

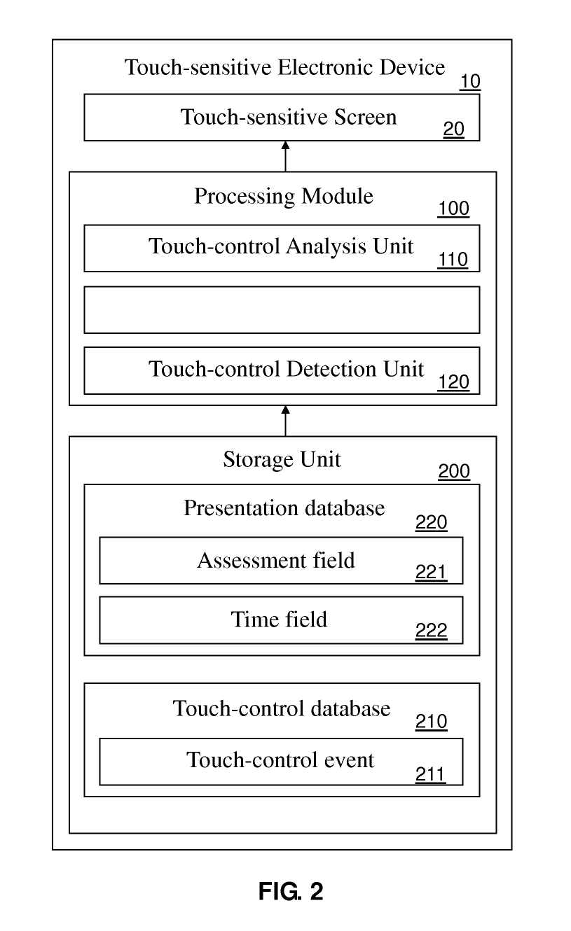

A touch sensitive electric device 10 as a representation device is represented in form of a tablet computer in FIG. 1. Such a device usually comprises an on-off-switch 11 and a central touch sensitive display and screen 20. FIG. 2 now shows a block diagram of the main electronic parts of the device 10 which are relevant for the invention. Of course, device 10 also comprises a battery, one or more interfaces (WLAN, 3G etc.) and further modules which are necessary for the use of the device but not relevant in view of features according to the invention.

Within the touch sensitive electronic device 10 is provided a storage unit 200 comprising a presentation database 220 and a touch-control database 210. The database 220 comprises e.g. the graphical presentation which could be provided according to the requirements of the operating system. For the WINDOWS operating system a popular software program is PowerPoint, for Android it is e.g. contained in an application called Polaris and for the Mac-system Keynote can be mentioned.

Furthermore, a touch-control database 210 is provided within the storage unit 200 comprising a number of touch-control events 211. At least two touch-control events are stored per presentation slide, in other words for every entry in the presentation database 220 at least two fields are provided in the touch-control database 210. The relevant pointer shows to the assessment field 221 within the presentation database 220.

Of course it is possible to create one single database comprising the touch-control events 211 and the assessment field 221 which can also be separately provided from the presentation slides.

Within the method according to the invention, a slide of the graphical representation is generated for representation on the screen 20 as well as a transparent window 40 which is provided as a rectangular frame on the left hand side of the screen 20. Of course it would also be possible to provide such a frame along a different side of the screen. It is preferable and an advantage, if the transparent window 40 is provided between the entire boundaries of the screen so that a user, here represented by his hand 45 can directly know where he has to touch to achieve a specific result. Although the window 40 could be visible as in the representation of FIG. 1 to demonstrate the function, it should usually be invisible for the user.

The transparent window 40 is divided into a number of touch-control events 211 here in eleven fields 41. These fields are marked in the representation of FIG. 1 from X and 1 to 10.

It is also possible to have a different number of elements 41, i.e. only two, one on the lower left hand side of the window and one of the upper side of the window; or any other number.

As soon as the user with his hand 45 touches the transparent window region 40 a specific touch-control event 211 as field 41 is chosen. Then this information is used by the processing module 100 within a touch-control detection unit 120 to assert which touch-control event 211 was triggered and that touch-control event is attributed within the touch-control analysis unit 110 to a specific assessment value which is stored in the assessment field 221 relating to the presentation database 220. In other words, in the present example as shown in FIG. 1 a value “6” is stored. The window 40 usually is invisible and does not hinder the representation of elements 30. It is possible to make the window visible over the entire time or only during a moment, when a specific field is touched. The value attributed to the assessment field 221 can be e.g. the impression that the presenter of the slide has when he sees the reaction of the public. In this respect it is possible to touch several times the window 40 before going to the next slide through the cursor 31 or to another slide via another element on the touchscreen as e.g the backward arrow 32. Only the last touched assessment value is stored in field 221. Therefore, the user can correct his initial assessment of the slide until representation of this slide is finished.

It is also possible that the touch of the touch-control event 211 in the field 40 also triggers the forward button to go into the next slide so that only one and final assessment can be given with the advantage that it cannot be forgotten, because this could be the only way to go forward in the slides.

Besides the assessment field 221 it is possible that a field like the window field “X” 41 is used to mark a special event so that afterwards the database having values for the impression of the slides can be augmented with the specific written description which is claimed from the presenter if any slides have received the mark X. Then using the touch event 211 for such a mark X would trigger a flagging of the field in question.

The window 40 of FIG. 1 covers 10% of the screen 20 and is divided from bottom to top into eleven distinct equal areas, which can be called hotspots.

During a discussion the presenter of the slides can click on any of these hotspots and therefore give directly an emotional feedback to the particular page or slide which can be generated beside based on the mentioned representations programs also be a simple aggregation of pages as a PDF or a multi-page Tiff.

Additionally, the presentation database can comprise a time field 222 which is filled with the cumulative time values the user stayed on a specific slide or page. This value is separately recorded and gives together with the assessment value a tool to analyze the impression and feedback of slides. If e.g. some of the slides are—over a number of representations—not shown at all or only for a very short time, then the question arises, if it is necessary to include them in the presentation. On the other side, if a slide has a very long representation time and a bad value, then this slide has to be improved. However, these functions are stemming from the technical solution to provide and fill an assessment field value 221 and optional a time field 222 being filled, when specific touch-screen event fields 211 are activated during a representation.

LIST OF REFERENCE SIGNS

| | |
|---|---|
| 10 | electronic device |
| 11 | on-off switch |
| 20 | display and touch-screen |
| 30 | slide |
| 31 | forward touch-screen event |
| 32 | backward touch, screen event |
| 40 | transparent window |
| 41 | touch screen event |
| 45 | hand of a user |
| 100 | processing module |
| 200 | storage unit |
| 210 | touch-control database |
| 211 | touch-control event |
| 220 | presentation database |
| 221 | assessment field |
| 222 | time field |

1. A window operation method, for use in an electronic device comprising a touch-sensitive screen, a storage unit and a processing module, wherein pointers to slides of a graphical presentation are stored in a database within the storage unit, wherein the method comprises the steps of:
a) storing a touch-control database comprising at least two touch-control events and an assessment field in the storage unit for each pointer to a slide,
b) generating a slide of the graphical representation and a transparent window,
c) displaying the slide of the graphical representation and the transparent window on top of it on the touch-sensitive screen by the processing module, wherein the transparent window comprises said touch-control events,
d) analyzing a touch-control command received via the touch-sensitive screen by the processing module,
e) determining whether the touch-control command conforms to one of the stored touch-control events, wherein, when the touch-control command conforms to one of the stored touch-control events, an assessment figure is stored in the assessment field in the storage unit for the current pointer to a slide.

2. The method according to claim 1, wherein any of the touch-control events is also adapted to trigger, after execution of step e) the generation of the next slide according to step b).

3. The method according to claim 1, wherein, when the touch-control command is given over an extended period of time, that then the transparent window turns visible and shows and displays the fields relating to the at least two touch screen events.

4. The method according to claim 1, wherein the storage unit also comprises a time field, within which upon going to the next slide, the time of representation of the given slide is stored.

5. The method according to claim 1, wherein in the case of multiple subsequent activation of a touch-control event only the last received in time is stored.

6. The method according to claim 1, wherein the touch-screen events comprise gestures replacing specific fields or additionally to them.

7. A touch-sensitive electronic device, comprising: a storage unit storing a touch-control database comprising at least two touch-control events; a touch-sensitive screen receiving a touch-control command or gesture, wherein the device is adapted to display a sequence of slides of a graphical presentation; and a processing module electrically coupled to the storage unit and the touch-sensitive screen, adapted to analyze the touch-control commands or gesture to determine whether the touch-control gesture conforms to any one of the touch-control events, and when the touch-control command or gesture conforms to one of the touch-control events, it is further adapted to store an assessment figure in the assessment field in the storage unit for the current pointer to a slide.
